(19) United States
(12) Patent Application Publication
(10) Pub. No.: US 2018/0269717 A1
(43) Pub. Date: Sep. 20, 2018

(54) ELECTRIC POWER TRANSMISSION DEVICE AND ELECTRIC POWER TRANSMISSION SYSTEM

(71) Applicant: KABUSHIKI KAISHA TOSHIBA, Tokyo (JP)

(72) Inventors: Tetsu SHIJO, Setagaya Tokyo (JP); Koji OGURA, Tachikawa Tokyo (JP); Masatoshi SUZUKI, Susono Shizuoka (JP); Yasuhiro KANEKIYO, Yokohama Kanagawa (JP); Kenichirou OGAWA, Kawasaki Kanagawa (JP); Shuichi OBAYASHI, Yokohama Kanagawa (JP); Masaaki ISHIDA, Kawasaki Kanagawa (JP)

(21) Appl. No.: 15/692,275

(22) Filed: Aug. 31, 2017

(30) Foreign Application Priority Data
Mar. 15, 2017 (JP) 2017-050052

(51) Int. Cl. H02J 50/10; H02J 50/40

(52) U.S. Cl. CPC H02J 50/10; H02J 7/025; H02J 50/40

(57) ABSTRACT

A power transmission device in a mode of the present invention includes a first power transmitter configured to generate a first magnetic field; and a second power transmitter configured to generate a second magnetic field having a phase opposite to a phase of the first magnetic field. Further, changing a frequency of the first magnetic field to a new value by the first power transmitter and changing a frequency of the second magnetic field to the new value by the second power transmitter are performed at the same timing.

### CROSS-REFERENCE TO RELATED APPLICATION(S)

This application is based upon and claims the benefit of priority from Japanese Patent Application No. 2017-050052, filed Mar. 15, 2017; the entire contents of which are incorporated herein by reference.

### FIELD

An embodiment relates to an electric power transmission device and an electric power transmission system.

### BACKGROUND

To charge a battery installed in an electric vehicle, a mobile terminal, or the like, the use of contactless electric power transmission schemes is increasing by which power charging or power supplying are realized in a contactless manner while utilizing a mutual induction between coils. During such contactless electric power transmission, an electromagnetic field occurs due to a radio frequency current flowing in the coils. There is a possibility that the electromagnetic field may cause electromagnetic interference with broadcast, wireless communication, and the like. To cope with this situation, limits of electromagnetic disturbance are determined by international standards and the like, with respect to the strength of the electromagnetic field. However, as the rated electric power to be transmitted increases, the strength of the electromagnetic field also increases. For this reason, it is not possible to easily increase the transmittable rated electric power.

To enhance the transmittable rated electric power, a measure has been taken by which multiple power transmission blocks are used. Further, a method is known by which the strength of a magnetic field is kept low by performing opposite phase power transmission in which either the directions or the phases of the electric currents in two blocks are arranged to be opposite to each other. However, a problem remains where, because an increasing rated electric power is in demand, the strength of the magnetic field may exceed the limits determined by the standards and the like even when the measure described above is taken.

### BRIEF DESCRIPTION OF THE DRAWINGS

FIG. 1 is a diagram for explaining an electric power transmission system according to an embodiment of the present invention;

FIG. 2 is a diagram illustrating an example of a configuration of each radio frequency current generator;

FIG. 3 is a diagram illustrating another example of a configuration of the radio frequency current generator;

FIG. 4 is a drawing for explaining a spread spectrum process performed in the present embodiment;

FIG. 5 is a chart illustrating a relationship between magnetic field strengths and frequencies related to electromagnetic interference at points in time when frequencies of two blocks are equal to each other;

FIG. 6 is a drawing for explaining a spread spectrum process that is unable to achieve an opposite phase effect;

FIG. 7 is a chart illustrating a relationship between magnetic field strengths and frequencies related to electromagnetic interference at points in time when the frequencies of the two blocks are not equal to each other;

FIG. 8 is a chart for explaining an operation of a DC-DC converter performed when changing a duty ratio; and

FIG. 9 is a diagram illustrating an example of a configuration of each rectifier.

### DETAILED DESCRIPTION

According to an embodiment of the present invention, in a contactless electric power transmission system (hereinafter, “contactless power transmission system”) including a plurality of electric power transmission blocks (hereinafter “power transmission blocks”), magnetic field strengths are kept low by performing a spread spectrum process while achieving an opposite phase effect.

An electric power transmission device (hereinafter, “power transmission device”) in a mode of the present invention includes a first power transmitter configured to generate a first magnetic field; and a second power transmitter configured to generate a second magnetic field having a phase opposite to a phase of the first magnetic field. Further, changing a frequency of the first magnetic field to a new value by the first power transmitter and changing a frequency of the second magnetic field to the new value by the second power transmitter are performed at the same timing.

An embodiment will be explained in detail below with reference to the accompanying drawings. The present invention is not limited to the embodiment.

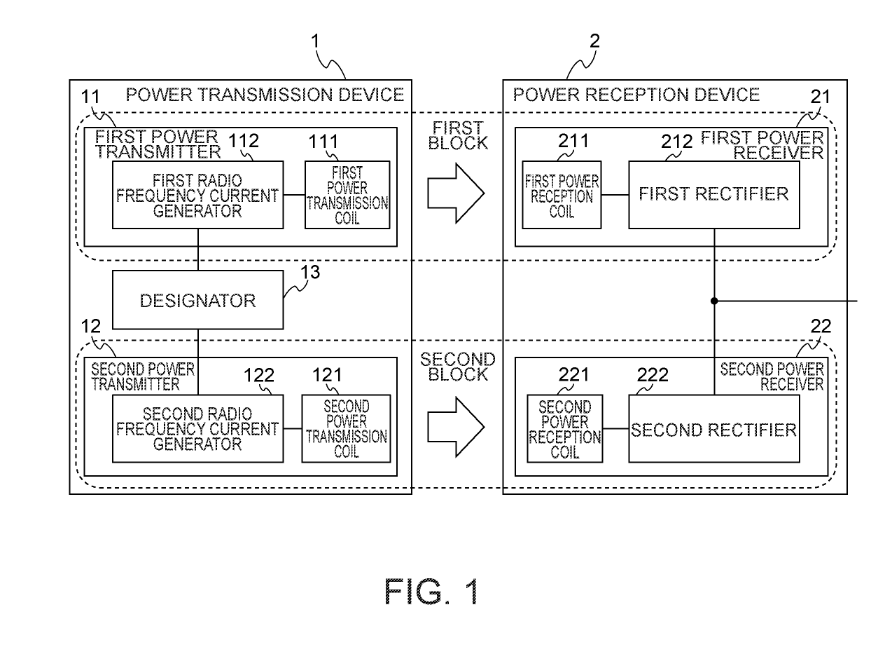

FIG. 1 is a diagram for explaining a power transmission system according to an embodiment of the present invention. The power transmission system illustrated in FIG. 1 includes a power transmission device 1 and a power reception device 2.

The power transmission device 1 includes two power transmitters and a designator 13. The two power transmitters will be referred to as a first power transmitter 11 and a second power transmitter 12. Each of the power transmitters includes a power transmission coil and a radio frequency current generator. The power transmission coil of the first power transmitter 11 will be referred to as a first power transmission coil 111, whereas the power transmission coil of the second power transmitter 12 will be referred to as a second power transmission coil 121. The radio frequency current generator of the first power transmitter 11 will be referred to as a first radio frequency current generator 112, whereas the radio frequency current generator of the second power transmitter 12 will be referred to as a second radio frequency current generator 122.

The power reception device 2 includes two power receivers. The two power receivers will be referred to as a first power receiver 21 and a second power receiver 22. Each of the power receivers includes a power reception coil and a rectifier. The power reception coil of the first power receiver 21 will be referred to as a first power reception coil 211, whereas the power reception coil of the second power receiver 22 will be referred to as a second power reception coil 221. The rectifier of the first power receiver 21 will be referred to as a first rectifier 212, whereas the rectifier of the second power receiver 22 will be referred to as a second rectifier 222.

In the present power transmission system, it is assumed that electric power is transmitted from the power transmission device 1 to the power reception device 2, by using magnetic fields generated by an electromagnetic induction. In other words, the present power transmission system is a contactless power transmission system. Further, for the purpose of transmitting as large a volume of electric power as possible while keeping the magnetic field strengths in the power transmission system of the present embodiment lower than limits, at least two power transmission blocks are provided. In the following sections, the power transmission blocks will simply be referred to as blocks.

In FIG. 1, the first power transmitter 11 and the first power receiver 21 structure a first block. Further, the second power transmitter 12 and the second power receiver 22 structure a second block.

Further, in the present embodiment, an opposite phase process is performed. The opposite phase process is to arrange the phases of two magnetic fields interfering with each other to be opposite to each other. In the present embodiment, the phases of the magnetic fields occurring from the blocks are arranged to be opposite to each other. As a result, because the occurring magnetic fields cancel out each other, it is possible to achieve an opposite phase effect where the magnetic field strengths are reduced. The opposite phase process is performed by adjusting either the directions or the phases of the electric currents generating the magnetic fields.

Further, in the present embodiment, a spread spectrum process is performed. The spread spectrum process is to change the spectrum (the frequency) of an occurring magnetic field within a predetermined range. For example, by changing a switching frequency used when a radio frequency current (an RF current) that causes the occurrence of a magnetic field is generated, the frequency of the occurring magnetic field is changed (spread). It is known that, with this arrangement, the strength of the occurring magnetic field is reduced, compared to the situation where the frequency of the occurring magnetic field is constant.

In other words, the power transmission system according to the present embodiment is configured to keep the magnetic field strengths low, by performing both the opposite phase process and the spread spectrum process. It should be noted, however, that control is exercised in the present embodiment, also for the purpose of bringing out the effects of both the opposite phase process and the spread spectrum process. Details of the control will be explained later.

The power transmission device 1 is configured to supply the electric power to the power reception device 2 by generating the magnetic fields. At that time, the power transmission device 1 performs the opposite phase process and the spread spectrum process.

The two power transmission coils generate the magnetic fields as a result of the electric currents flowing. When the magnetic field occurring from the first power transmission coil 111 reaches the first power reception coil 211, mutual coupling occurs between the first power transmission coil 111 and the first power reception coil 211. As a result, the first power reception coil 211 receives the electric power from the first power transmission coil 111. Similarly, when the magnetic field occurring from the second power transmission coil 121 reaches the second power reception coil 221, mutual coupling occurs between the second power transmission coil 121 and the second power reception coil 221. As a result, the second power reception coil 221 receives the electric power from the second power transmission coil 121. In this manner, the electric power is transmitted in a contactless manner. In this situation, the magnetic field occurring from the second power transmission coil 121 has a phase opposite to the phase of the magnetic field occurring from the first power transmission coil.

Examples of types of coils include solenoid types and spiral types, which are based on windings and positional arrangements of ferrite cores. The coils described above may be of any type. Also, the first power transmission coil 111 and the second power transmission coil 121 may be of mutually-different types.

The two radio frequency current generators are each configured to generate a radio frequency current and to send the generated radio frequency current to a corresponding one of the power transmission coils. In the present example, it is assumed that the first radio frequency current generator 112 generates a first radio frequency current and sends the generated first radio frequency current to the first power transmission coil 111. It is also assumed that the second radio frequency current generator 122 generates a second radio frequency current and sends the generated second radio frequency current to the second power transmission coil 121. As a result, two magnetic fields occur from the two power transmission coils. In addition, to further achieve the opposite phase effect, either the phases or the directions of the first and the second radio frequency currents are determined.

Let us assume that it is determined in advance in what manner the phases or the directions of the electric currents are adjusted. When the opposite phase effect is to be achieved by using the phases of the radio frequency currents, the phases of the two radio frequency currents are arranged to be opposite. In contrast, when the opposite phase effect is to be achieved by using the directions of the radio frequency currents, the directions of the electric currents will vary depending on the winding directions of the windings of the two power transmission coils. When the winding directions of the windings of the two power transmission coils are the same as each other, the directions of the two radio frequency currents are arranged to be opposite to each other. On the contrary, when the winding directions of the windings of the two power transmission coils are different from each other, the directions of the two radio frequency currents are arranged to be the same as each other. As explained herein, it is possible to achieve the opposite phase effect by configuring the radio frequency current generators to generate the radio frequency currents in such a manner that the phases of the magnetic fields occurring from the two power transmission coils are opposite to each other.

Further, to perform the spread spectrum process, each of the two radio frequency current generators is configured to change the frequency of the radio frequency current to a new value, at timing designated by the designator 13. In this situation, the two radio frequency current generators change the frequencies to mutually the same value. In other words, the frequency of the first radio frequency current and the frequency of the second radio frequency current are the same as each other at any point in time. The reason will be explained later.

The radio frequency current generators may change the frequencies of the radio frequency currents to a value designated by the designator 13. Alternatively, the radio frequency current generators may change the frequencies of the radio frequency currents to a predetermined value. For example, an arrangement is acceptable in which the radio frequency current generators each keep a table recording therein multiple frequency values, so that a value into which the frequency is to be changed is selected from the table. In that situation, the value of the frequency may be selected randomly. Alternatively, the values of the frequencies may be selected regularly (in a regular cycle). For example, when candidates for the values of the frequencies are f1, f2, f3, and f4, one of the candidates may sequentially be selected, always in the order of f1, f2, f3, and f4.

To ensure that the effect of the spread spectrum process is achieved, however, it should be noted that the value of the frequency after a change (a new value) shall be different from the value of the frequency immediately before the change. For example, when the frequency value at present is f1, it is sufficient as long as the immediately preceding frequency value is f2, which is different from f1. It is acceptable even when the frequency value that immediately precedes the immediately-preceding frequency value f2 is f1.

The values of the frequencies may be calculated by using a pseudorandom number. Alternatively, the values of the frequencies may be a plotted value in a periodic function chart of a sine wave or the like. To stabilize the transmitted electric power and the current values of the radio frequency currents, however, it is desirable to arrange the frequency values to change in the form of a sine wave.

The radio frequency current generators may each be realized by using a circuit. For example, the radio frequency current generators may each include an inverter, a rectifier, a Power Factor Correction (PFC) circuit, a voltage transformation circuit, and/or the like.

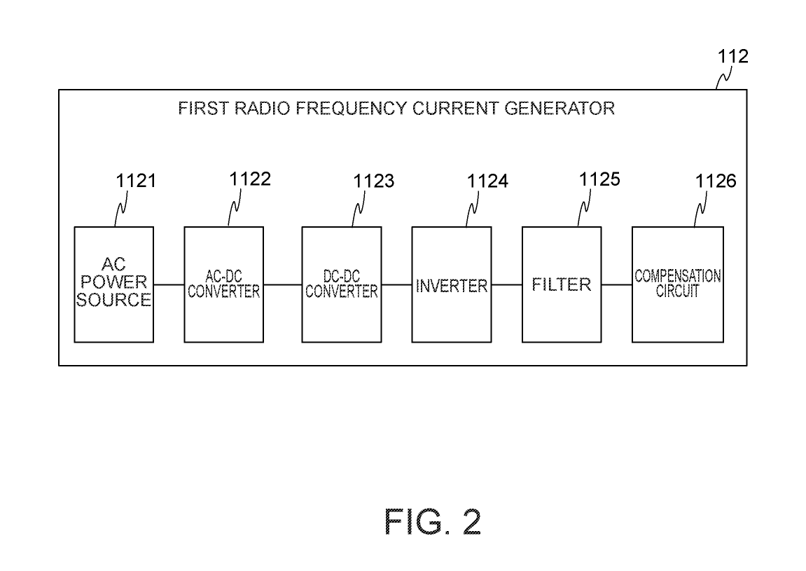

FIG. 2 is a diagram illustrating an example of a configuration of each of the radio frequency current generators. Although FIG. 2 illustrates the first radio frequency current generator 112, the second radio frequency current generator 122 has the same configuration. The first radio frequency current generator 112 includes an AC power source 1121, an AC-DC converter 1122, a DC-DC converter 1123, an inverter 1124, a filter 1125, and a compensation circuit 1126. The constituent elements of each of the radio frequency current generators are not limited to those illustrated in FIG. 2. When processes performed by any of the constituent elements are unnecessary, such a constituent element may be omitted.

The AC power source 1121 is configured to supply an alternating current to the AC-DC converter 1122. The AC power source may be a three-phase power source or a single-phase power source. The AC-DC converter 1122 is configured to convert an alternating current to a direct current. The AC power source may have connected thereto a power factor correction circuit, a rectifier, and/or the like. The AC-DC converter 1122 is configured to convert the supplied alternating current into the direct current.

The DC-DC converter 1123 is configured to convert a direct current sent thereto into a current having a desired voltage (by either raising or lowering the voltage). In place of the DC-DC converter 1123, an inverter may transform the voltage by exercising a phase shift control. In that situation, the DC-DC converter 1123 may be omitted.

The inverter 1124 is configured to convert a direct current into an alternating current having a desired frequency. With these arrangements, the radio frequency current is generated, and the frequency is converted.

The filter 1125 is configured to reduce harmonic components of the radio frequency current output from the inverter 1124. The filter 1125 thus lowers the magnetic field strength that may cause electromagnetic interference to be lower than the limits. In this situation, the filter 1125 may be structured by using a capacitor, an inductor, or a combination of a capacitor and an inductor. The compensation circuit 1126 is configured to correct the radio frequency current before the radio frequency current is sent to the power transmission coil, for the purpose of correcting the power factor and reducing the phase difference between the current and the voltage. For example, the compensation circuit 1126 may be structured by using a capacitor or the like. The capacitor may be connected either in series to or in parallel to the power transmission coil. The radio frequency current generated and adjusted in this manner is sent to the power transmission coil.

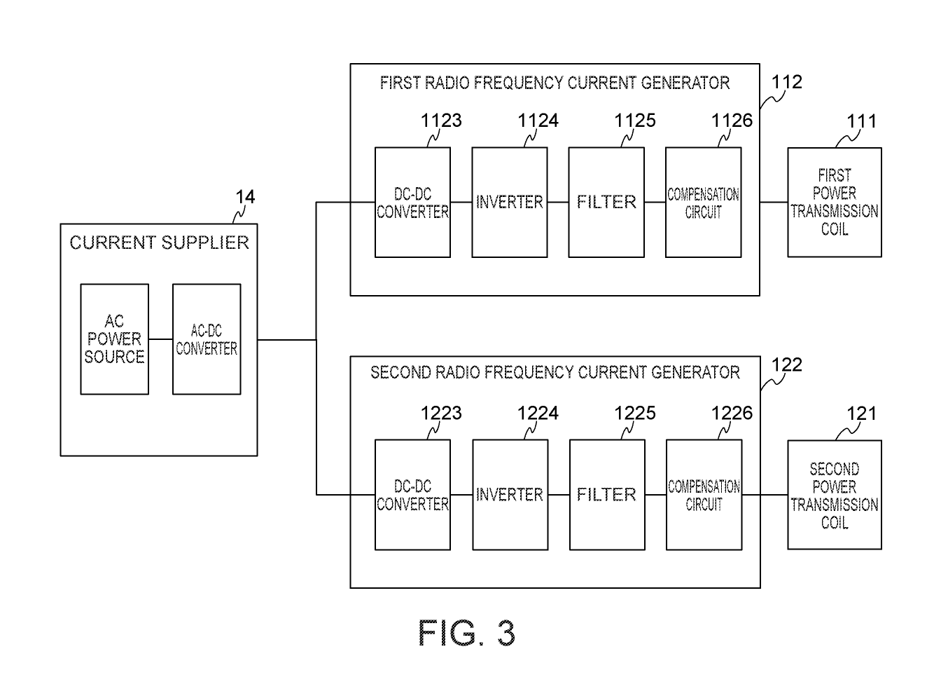

The first radio frequency current generator and the second radio frequency current generator may have one or more constituent elements that are used in common therebetween. FIG. 3 is a diagram illustrating another example of configurations of the radio frequency current generators. In the example in FIG. 3, the AC power source and the AC-DC converter are provided on the outside of the first radio frequency current generator 112 and the second radio frequency current generator 122 and structured as a current supplier 14 configured to supply a direct current to both the first radio frequency current generator 112 and the second radio frequency current generator 122. As described herein, a part of either of the radio frequency current generators may be positioned on the outside of the radio frequency current generators themselves or the power transmission device 1.

The designator 13 is configured to designate timing with which changing the frequencies is to be performed, for the first radio frequency current generator 112 and the second radio frequency current generator 122. Although FIG. 1 illustrates the example in which the single designator (the designator 13) designates the timing for the two radio frequency current generators, another arrangement is also acceptable in which the power transmission device 1 includes two designators, so that each of the designators designates timing for a corresponding one of the radio frequency current generators. In that situation, each of the radio frequency current generators may include a different one of the designators. It is assumed that the timing is the same for the first radio frequency current generator 112 and for the second radio frequency current generator 122. The reason is that, if there were a period of time during which the frequencies of the two radio frequency currents are different from each other, it would be impossible to achieve the effect of the opposite phase process during that period.

As long as the designator 13 is able to provide the two radio frequency current generators with the same timing, the configuration of the designator 13 is not particularly limited. For example, a clock signal may directly be transmitted to each of the two radio frequency current generators. Alternatively, the frequency of a clock signal may be divided so as to transmit a signal having a cycle with which an inverter is to operate.

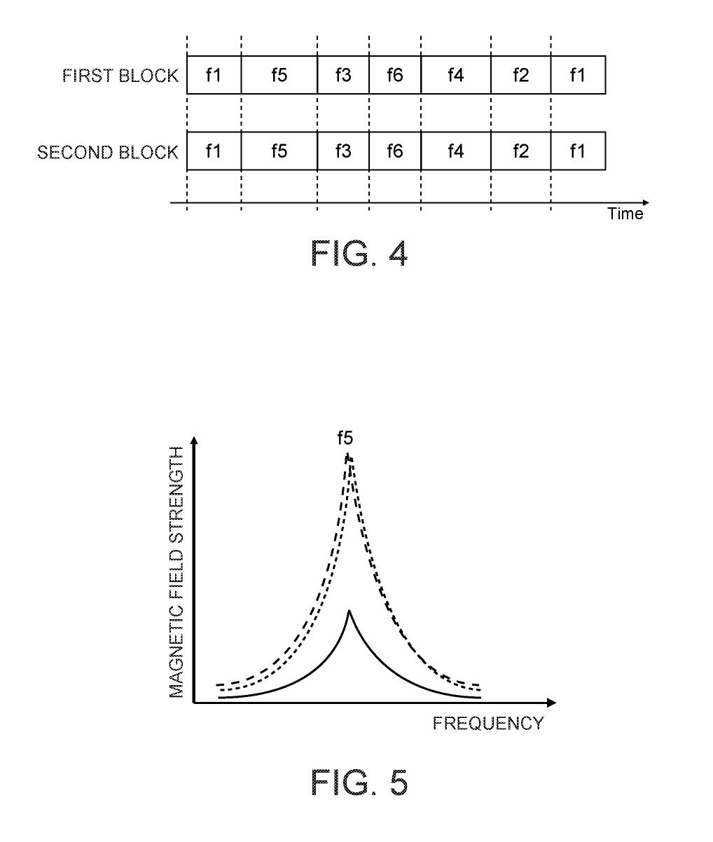

FIG. 4 is a drawing for explaining a spread spectrum process performed in the present embodiment. Each of the blocks (rectangles) illustrated in FIG. 4 denotes a period of time during which the radio frequency currents have mutually the same frequency. In other words, the boundaries of the blocks indicated with the dotted lines correspond to the timing designated by the designator 13 with which the frequency is changed. The plurality of blocks positioned in the top section of FIG. 4 represent time periods related to the first block. The plurality of blocks positioned in the bottom section of FIG. 4 represent time periods related to the second block. The set of a letter and a numeral in each of the blocks indicate the frequency of the radio frequency current in the period of time. The frequency of the radio frequency current is the same as the frequency of the magnetic field.

As indicated by the width of each of the blocks in FIG. 4, the intervals of the timing (i.e., the time interval between a time when the frequencies are changed and a subsequent time when the frequencies are changed again) do not necessarily have to be regular. The length of each of the time intervals may be determined in accordance with the frequencies of the radio frequency currents during the time interval. In the following sections, the time intervals will be referred to as “frequency change intervals”.

As illustrated in FIG. 4, the frequency value in each of the period of time is arranged to be different from the frequency value in the immediately following period of time. The spread spectrum process is thus performed. Further, in FIG. 4, the frequency change timing is the same between the two blocks. Accordingly, at any point in time, the frequencies of the two blocks are the same as each other.

FIG. 5 is a chart illustrating a relationship between magnetic field strengths and frequencies related to electromagnetic interference at points in time when the frequencies of the two blocks are equal to each other. The frequencies of the two magnetic fields in FIG. 5 are both f5. The broken line (drawn with line segments arranged with wider gaps) indicates the frequency of the magnetic field occurring from the first block. The dotted line (drawn with line segments arranged with smaller gaps) indicates the frequency of the magnetic field occurring from the second block. The solid line indicates the frequency of a synthesized wave formed by the magnetic fields occurring from the two blocks.

Because the frequencies of the magnetic fields occurring from the two blocks are equal to each other, the magnetic fields occurring from the two blocks cancel out each other as a result of the opposite phase process. The magnetic field strength of the synthesized wave is therefore lower than the original magnetic field strengths. In other words, according to the present embodiment, it is also possible to achieve the opposite phase effect even when the spread spectrum process is performed.

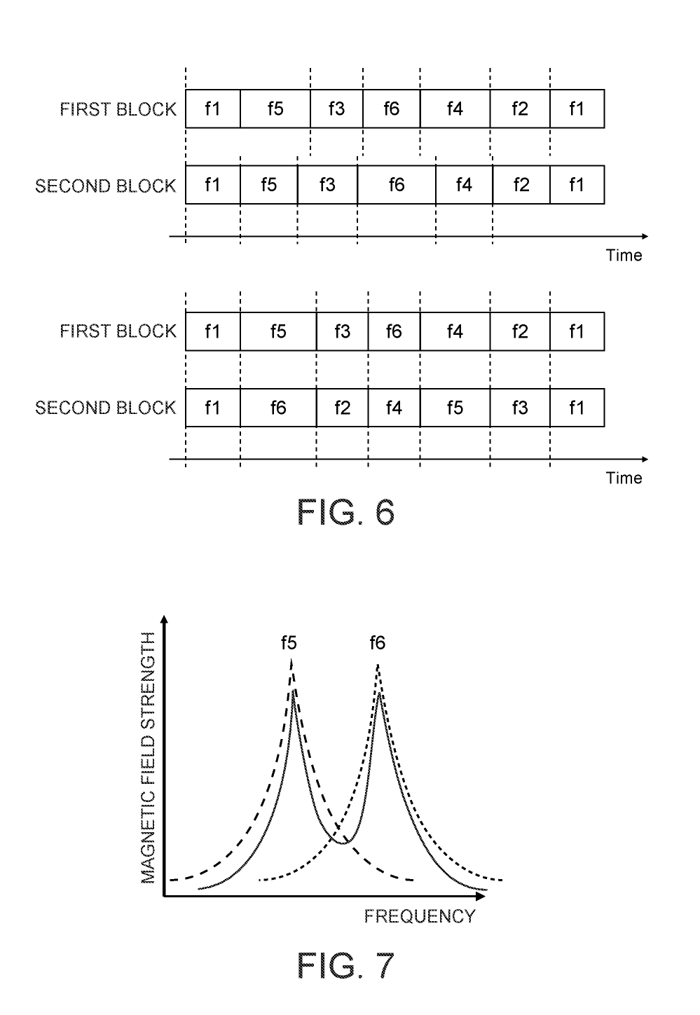

FIG. 6 is a drawing for explaining a spread spectrum process that is unable to achieve the opposite phase effect. The drawing in the top section of FIG. 6 illustrates an example in which, although the changing frequency values are the same between the two blocks, the frequency change timing is different between the two blocks. In contrast, the drawing in the bottom section of FIG. 6 illustrates an example in which, although the frequency change timing is the same between the two blocks, the changing frequency values are different between the two blocks. In these situations, at certain points in time, the frequency used in the first block is different from the frequency used in the second block.

FIG. 7 is a chart illustrating a relationship between magnetic field strengths and frequencies related to electromagnetic interference at points in time when the frequencies of the two blocks are not equal to each other. It is assumed that the frequency of the first block indicated with the broken line is f5, whereas the frequency of the second block indicated with the dotted line is f6. As illustrated in FIG. 7, the charts of the two blocks have peaks in the positions different from each other. Accordingly, even when the opposite phase process is performed, the magnetic fields occurring from the two blocks do not cancel out each other. It is therefore impossible to achieve the opposite phase effect, and the synthesized wave exhibits two types of frequency characteristics.

As explained above, even when both the opposite phase process and the spread spectrum process are performed, it would be impossible to achieve the effects of both processes, either when the frequency change timing is different between the two blocks or when the changing frequency values are different between the two blocks. Accordingly, in the present embodiment, the two radio frequency current generators change the frequencies to mutually the same value by using the same timing. Consequently, it is also possible to achieve the effect of the opposite phase process even when the spread spectrum process is performed.

To arrange the frequency of the first radio frequency current to be the same as the frequency of the second radio frequency current, it is suggested that switching operations of the inverter 1124 included in the first radio frequency current generator be in synchronization with switching operations of the inverter 1224 included in the second radio frequency current generator.

Incidentally, when the frequencies are changed, the level of the transmitted electric power fluctuates. When the level of electric power supplied thereto is unstable, such as electronic devices and batteries are prone to be degraded or to have a malfunction. In addition, there are some situations where it is necessary to supply a constant current and a constant voltage, such as when lithium ion batteries are charged, for example. For these reasons, when the electric power received by the power reception device 2 fluctuates, it is necessary to provide, on the power reception device 2 side, a function capable of inhibiting the fluctuation in the electric power level. Furthermore, the current values of the radio frequency currents and the magnetic fields related to electromagnetic interference are also affected unfortunately.

To cope with these situations, it is a good idea to keep the level of the transmitted electric power constant, by increasing or decreasing the voltage or the current of each of the radio frequency currents so as to complement the amount of transmitted electric power either increased or decreased due to the spread spectrum process. For example, the DC-DC converter included in each of the radio frequency current generators may be configured to adjust the voltage of the radio frequency current (to adjust the ratio of transformation) by changing the duty ratio. Alternatively, the inverter included in each of the radio frequency current generators may be configured to adjust the voltage or the current of the radio frequency current by exercising phase control.

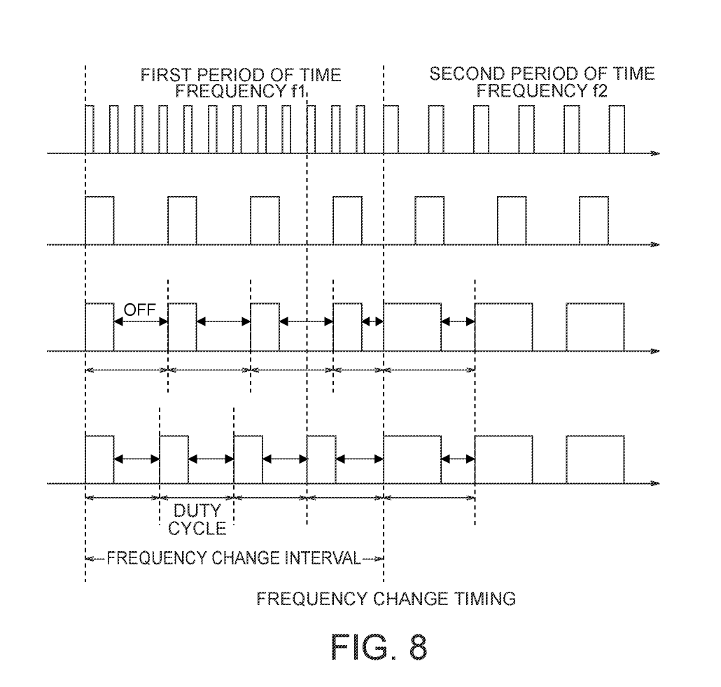

However, simply changing the duty ratio would cause a problem. FIG. 8 is a chart for explaining an operation of the DC-DC converter performed when changing the duty ratio. FIG. 8 illustrates a first period of time in which the frequency is expressed as f1, and a second period of time in which the frequency is expressed as f2.

The first chart (the pulse wave) from the top of FIG. 8 indicates the state of the inverter (whether the inverter is on or off). The cycle (the duty cycle) of the inverter being on and off changes by using the frequency change timing indicated in FIG. 8. As a result, the frequency of the radio frequency current is changed. The second chart from the top of FIG. 8 indicates the state of the DC-DC converter when the duty ratio is not changed. In that situation, because the ratio of transformation is not changed although the frequency is changed, the level of transmitted electric power fluctuates.

The third chart from the top of FIG. 8 indicates an operation of the DC-DC converter performed when changing the duty ratio by using the frequency change timing. It is observed that the percentage of the “ON” period with respect to the duty cycle is higher during the second period of time than during the first period of time. In other words, the duty ratio has increased in the second period of time. Consequently, the transmitted electric power is complemented. However, the “OFF” period immediately preceding the time at which the frequency is changed (hereinafter “frequency change time”) is shorter than each of the “OFF” periods prior thereto. The reason is that the frequency change time arrives while the DC-DC converter is in the “OFF” state. Consequently, the duty ratio at the end of the first period of time is different from the duty ratios observed up to that point in the first period of time. As a result, the transmitted electric power fluctuates at the end of the first period of time.

To avoid the situation described above, in the present embodiment, it is acceptable to adjust the frequency change timing as well as the duty cycle of the DC-DC converter. More specifically, the DC-DC converter arranges the duty cycle to be a value obtained by multiplying the cycle of the radio frequency current by an integer (a value obtained by dividing the frequency of the radio frequency current by an integer). Further, the frequency change intervals are each arranged to be a time length obtained by multiplying the duty cycle by an integer.

The fourth chart from the top of FIG. 8 indicates an example in which the duty cycle is arranged to be one third of the frequency of the radio frequency current, whereas the frequency change intervals are each arranged to be four times as long as the duty cycle. In this situation, as indicated in the fourth chart, the time at which the DC-DC converter finishes being in the OFF state is the same as the time at which the frequency is changed. Accordingly, unlike in the third chart, the duty ratio does not fluctuate during the first period of time. Further, the DC-DC converter increases the duty ratio in the second period of time, in the same manner as in the third chart. Consequently, it is possible to keep the level of the transmitted electric power constant.

In the manner described above, it is possible to constantly keep low the magnetic field strengths occurring from the power transmission device 1. In addition, it is also possible to keep the level of the transmitted electric power constant.

The power reception device 2 is configured to receive the electric power generated from the two power reception coils due to a mutual induction. Similarly to the power transmission coils, the power reception coils may be of any type. The first power reception coil 211 and the second power reception coil 221 may be of mutually-different types.

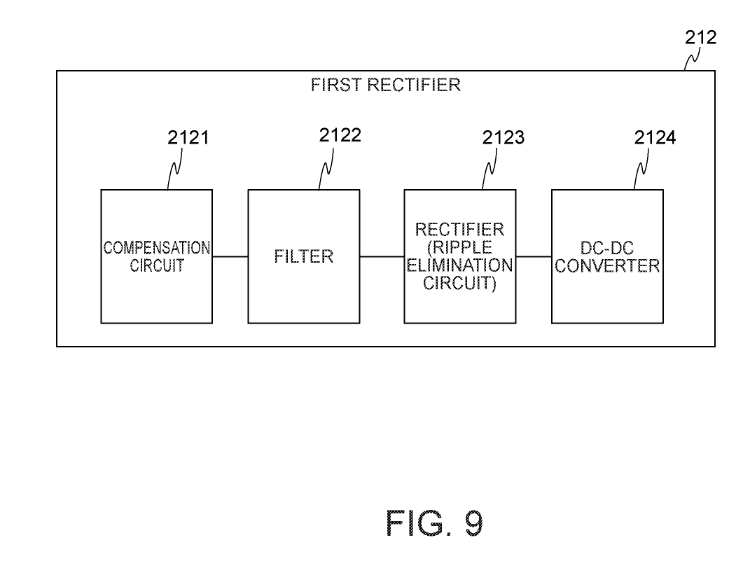

Each of the two rectifiers is configured to rectify the radio frequency current flowing from a corresponding one of the power reception coils and to cause the rectified current to flow to a battery, another device, of the like. FIG. 9 is a diagram illustrating an example of a configuration of each of the rectifiers. Although FIG. 9 illustrates the first rectifier 212, the second rectifier 222 has the same configuration. The first rectifier 212 includes a compensation circuit 2121, a filter 2122, a rectifier (a ripple elimination circuit) 2123, and a DC-DC converter 2124. As long as the rectifiers are each able to rectify the radio frequency current, the rectifiers may have any configuration. Possible configurations thereof are not limited to the example illustrated in FIG. 9. When processes performed by any of the constituent elements are unnecessary, such a constituent element may be omitted.

The radio frequency current supplied from the first power reception coil 211 is transferred to the rectifier 2123 via the compensation circuit 2121 and the filter 2122. The compensation circuit 2121 may also be structured by using a capacitor or the like. The capacitor may be connected in series to or in parallel to the first power reception coil 211. The filter 2122 may also be structured by using a capacitor, an inductor, or a combination of these. When the magnetic field strength that may cause electromagnetic interference is sufficiently lower than the limits, the filter 2122 may be omitted.

The rectifier 2123 may be structured by using, for example, a full-bridge diode. The rectified current contains many ripple components. Accordingly, for the purpose of eliminating the ripples, the rectifier may include a ripple elimination circuit structured by using a capacitor, an inductor, or a combination of these. The DC-DC converter 2124 is configured to transform the voltage after the rectification is performed by the rectifier 2123. In this manner, the current to which the rectification and the transformation have been applied is sent to a battery or the like.

As explained above, for the purpose of achieving the effects of both the spectrum spread process and the opposite phase process, the power transmission device 1 according to the present embodiment arranges the first block and the second block to have the same changing frequency values as each other and to use the same frequency change timing as each other. With this arrangement, even when the spread spectrum is performed, the frequencies of the magnetic fields occurring from the two blocks are the same as each other. Consequently, because the magnetic fields cancel out each other, it is possible to achieve an effect where the magnetic field strengths related to electromagnetic interference are reduced.

Further, the duty ratio of the DC-DC converter may be adjusted for the purpose of keeping the level of transmitted electric power constant. In that situation, it is possible to prevent the situation where the duty ratio fluctuates prior to the time at which the frequency is changed, due to the adjustments made in the frequency change timing and the duty cycle of the DC-DC converter. Consequently, it is possible to prevent the level of the transmitted electric power from fluctuating and the radio frequency current from increasing or decreasing.

It is assumed that the processes according to the present embodiment are realized in a dedicated circuit. However, some of the processes that are related to controlling a circuit, such as designating the frequency change timing, may be realized as a result of a CPU executing a program stored in a memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electric power transmission device comprising:
a first power transmitter configured to generate a first magnetic field; and
a second power transmitter configured to generate a second magnetic field having a phase opposite to a phase of the first magnetic field, wherein
changing a frequency of the first magnetic field to a new value by the first power transmitter and changing a frequency of the second magnetic field to the new value by the second power transmitter are performed at the same timing.

2. The electric power transmission device according to claim 1, wherein
the first power transmitter includes:
a first radio frequency current generator configured to generate a first radio frequency current; and
a first power transmission coil configured to generate the first magnetic field as a result of the first radio frequency current flowing,
the second power transmitter includes:
a second radio frequency current generator configured to generate a second radio frequency current; and
a second power transmission coil configured to generate the second magnetic field as a result of the second radio frequency current flowing, and
changing a frequency of the first radio frequency current to the new value by the first radio frequency current generator and changing a frequency of the second radio frequency current to the new value by the second radio frequency current generator are performed at the same timing.

3. The electric power transmission device according to claim 2, wherein
the second magnetic field is arranged to have the phase opposite to the phase of the first magnetic field, as a result of the second radio frequency current generator generating the second radio frequency current having a phase opposite to a phase of the first radio frequency current.

4. The electric power transmission device according to claim 2, wherein
the second magnetic field is arranged to have the phase opposite to the phase of the first magnetic field,
as a result of, when a winding direction of the first power transmission coil is same as a winding direction of the second power transmission coil, the second radio frequency current generator generating the second radio frequency current to be in a direction opposite to a direction of the first radio frequency current, or
as a result of, when a winding direction of the first power transmission coil is opposite to a winding direction of the second power transmission coil, the second radio frequency current generator generating the second radio frequency current to be in a same direction as a direction of the first radio frequency current.

5. The electric power transmission device according to claim 2, wherein
the first radio frequency current generator includes a first DC-DC converter,
the second radio frequency current generator includes a second DC-DC converter,
at a time when the frequencies of the first radio frequency current and the second radio frequency current are changed, the first DC-DC converter and the second DC-DC converter change a duty cycle to a value obtained by dividing the new value by an integer, and
a time interval between the time when the frequencies are changed and a subsequent time when the frequencies are changed again is a time length obtained by multiplying the post-change duty cycle by an integer.

6. The electric power transmission device according to claim 1, further comprising:
a designator configured to designate timing with which the frequencies are changed for the first power transmitter and the second power transmitter.

7. The electric power transmission device according to claim 1, wherein
a fluctuation in the frequency of the first magnetic field is in a form of a sine wave.

8. An electric power transmission system that includes a power transmission device and a power reception device and that transmits electric power in a contactless manner, wherein
the power transmission device comprises:
a first power transmitter configured to generate a first magnetic field; and
a second power transmitter configured to generate a second magnetic field having a phase opposite to a phase of the first magnetic field, and
the power reception device comprises:
a first power receiver configured to generate a radio frequency current by using the first magnetic field; and
a second power receiver configured to generate a radio frequency current by using the second magnetic field, and
changing a frequency of the first magnetic field to a new value by the first power transmitter and changing a frequency of the second magnetic field to the new value by the second power transmitter are performed at the same timing.
